(19) United States
(12) Patent Application Publication
(10) Pub. No.: US 2019/0226043 A1
(43) Pub. Date: Jul. 25, 2019

(54) METHODS FOR MANUFACTURING ULTRA-HARD AND WEAR-RESISTANT COMPOSITE BLADE

(71) Applicant: BMAN MANUFACTURING (ZHE JIANG) CO., LTD., Tong Xiang City, Zhejiang (CN)

(72) Inventor: Yu-chang CHIEN, Tong Xiang City, Zhejiang (CN)

(21) Appl. No.: 16/312,406

(22) PCT Filed: Mar. 31, 2017
(86) PCT No.: PCT/CN2017/078918

§ 371 Date: Dec. 21, 2018

(30) Foreign Application Priority Data
Jun. 23, 2016 (CN) 201610485843.4

(51) Int. Cl. C21D 9/18; C21D 6/00; B22D 19/16; C22F 1/18; C22F 1/10; B23K 31/02

(52) U.S. Cl. CPC C21D 9/18; C21D 6/004; B22D 19/16; C22F 1/183; B23P 15/40; B23K 31/025; C21D 2211/001; C21D 2211/008; C21D 2211/005; C22F 1/10

(57) ABSTRACT

A method for manufacturing an ultra-hard and wear-resistant composite blade, comprising the following steps: carrying out pre-blank-fabricating and pre-matrix-forming treatments on a blade matrix (2) material to form a preformed blank; adding an ultra-hard alloy material in the preformed blank by means of an ultra-high-temperature melting treatment; after cooling, machining and grinding according to the blade specifications to obtain the ultra-hard, wear-resistant and antirust composite blade. The composite blade manufactured using the method has ultra-high hardness, wear resistance and blank antirust performance; moreover, the cutting edge of the nanoscale ultra-hard alloy body is durable and sharp and is not liable to wear.

### RELATED APPLICATIONS

This application is the U.S. National Phase under 35 U.S.C. § 371 of International Application No. PCT/CN2017/078918, filed Mar. 31, 2017, which in turn claims the benefit of Chinese Application No. 201610485843.4, filed Jun. 23, 2016, the contents of which are incorporated herein by reference in their entirety.

### TECHNICAL FIELD

The present disclosure relates to methods of preparing blades, and more particularly, to methods of preparing ultra-hard and wear-resistant composite blades.

### BACKGROUND

The blade of a knife is usually made from a single material, such as a steel knife, a ceramic knife, and the like. These knives have sharp edges and are easy to cut. However, all-steel blades are usually made from a single high-carbon tool steel, an alloy tool steel, or a corrosion-resistant alloy steel. In this way, the consumption of hardness materials is increased, and so are the costs. In addition, the toughness of the tool steel after quenching process decreases and it is brittle and easy to chip, which lowers the impact resistance and increases danger during use. Ceramic blades are made of precision ceramic under high temperature and high pressure. They have the advantages of high wear resistance, high hardness, rust-resisting, easy to dean, and the like. But all-ceramic blades are not only costly and expensive, but also have lower toughness and are more brittle.

In the prior art, nickel-based, cobalt-based, and iron-based alloys, tungsten carbide composite material, high rust-resistant hard alloys and ceramic, and synthetic diamond are materials with relatively high hardness in the world. Ultra-hard alloy materials that are made by pulverization and high-temperature sintering of these materials show excellent usability and wide applicability in the fields of daily cutting tools and crushing tools. However, the ultra-hard alloy composite blades are assembled by using an ultra-hard alloy substrate and a corrosion-resistant base, which leads to insufficient fastness; and the ultra-hard material layer has a thin structure, which is weak and not suitable for tools.

The patent document CN101168230A discloses a method for preparing an ultra-hard composite blade, which comprises: drilling a preformed hole on a cemented carbide or high-speed steel plate which is to be the base of a blade; adding the ultra-hard material and the binder powder into the preformed hole under the protection of a sintering mold tool; and converting the materials in the preformed hole into an ultra-hard polycrystalline material by high-temperature and high-pressure sintering. Hence, this method requires formation of a preformed hole first and addition of a binder powder to strengthen the bonding fastness of the composite material, rendering a complicated process.

### SUMMARY

In view of deficiencies in the prior art, the present disclosure provides a method of preparing an ultra-hard and wear-resistant composite blade.

At least one object of the present disclosure is achieved by the following technical solutions.

In one aspect, the present disclosure provides a method for preparing an ultra-hard and wear-resistant composite blade, and the preparation method comprises:

Step A1, subjecting a blade base material to preform processing and base premolding processing to form a preformed body; and

Step A2, adding an ultra-hard alloy material to the preformed body, which is then subjecting to an ultra-high temperature melting treatment to produce a nanoscale ultra-hard alloy body;

Step A3, after cooling, processing and grinding, according to the blade specifications, the nanoscale ultra-hard alloy body to obtain an ultra-hard, wear-resistant and rust-resistant composite blade.

Preferably, the temperature of the ultra-high temperature melting treatment in Step A2 may be 1200 to 2700° C., and the process time may be 2 to 60 seconds. The temperature is chosen taking into account the melting temperature and temperature loss of different materials. If the temperature is too low, the material will not melt; while if the temperature is too high, the properties of the material will be disrupted.

Preferably, the shape of said preformed body may be a planar abutment or a curved abutment.

Preferably, said blade base material may include at least one selected from the group consisting of Martensitic stainless steel, ferritic stainless steel, Austenitic stainless steel, titanium alloy, and rust-resistant alloy.

Preferably, said ultra-hard alloy material may include at least one selected from the group consisting of nickel-based alloy, cobalt-based alloy, iron-based alloy, tungsten carbide composite material, high rust-resistant cemented carbide, ceramic, and synthetic diamond.

More preferably, said ultra-hard alloy material includes at least one selected from the group consisting of nickel-based alloy, tungsten carbide cobalt alloy, and ceramic.

Preferably the method of cooling may be air cooling or oil cooling.

More preferably, said cooling time may be 10 to 120 minutes and the temperature may be cooled to 10 to 100° C.

The present disclosure also provides an application of the ultra-hard and wear-resistant composite blade prepared according to the aforementioned method, which comprises use of said composite blades in preparing an ultra-hard and wear-resistant cutter, a single-side ultra-hard and wear-resistant cutter, or ultra-hard and wear-resistant scissors.

During preparation of the ultra-hard and wear-resistant composite blade of the present disclosure, it is unnecessary to add bonding agent to increase the bonding fastness of the composite material. Merely by instantaneously melting the object at a high temperature, the base material and the welding material are alloyed, so that the composite blade can be welded firmly and not easily be peeled off.

Compared with the prior art, the present disclosure has at least the following beneficial effects:

1. The composite blade prepared according to the present disclosure has ultra-high hardness, wear resistance and corrosion resistance.

2. The tip of the nanoscale ultra-hard alloy body can have durable sharpness, not easy to wear.

### BRIEF DESCRIPTION OF THE DRAWINGS

Other features, objects, and advantages of the present disclosure will become apparent from the detailed description of the non-limiting examples with reference to the following figures.

FIG. 1 shows a blade of an ultra-hard and wear-resistant cutter prepared according to Embodiment 1 of the present disclosure.

FIG. 2 shows a blade of a single-sided ultra-hard and wear-resistant cutter prepared according to Embodiment 2 of the present disclosure.

FIG. 3 shows blades of the ultra-hard and wear-resistant scissors prepared according to Embodiment 3 of the present disclosure.

Listing of referential signs: 1 is blade tip; 2 is blade base.

### DETAILED DESCRIPTION OF THE EMBODIMENTS

The present disclosure will be described in detail below with reference to the specific embodiments. The following examples are intended to further understand the disclosure, but are not intended to limit the disclosure in any way. It should be noted that a number of variations and modifications may be made by those skilled in the art without departing from the inventive concept. They all belong to the scope of protection of the present disclosure.

### Embodiment 1

This embodiment relates to a method for preparing an ultra-hard and wear-resistant composite blade of an ultra-hard and wear-resistant cutter, which comprises the following steps:

Step A1, subjecting the blade base material to preform processing and base premolding processing to form a preformed body; and

Step A2, adding an ultra-hard alloy material into the preformed body, which was then subjecting to an ultra-high temperature melting treatment to produce;

Step A3, after cooling, processing and grinding, according to the blade specifications, the nanoscale ultra-hard alloy body to obtain an ultra-hard, wear-resistant and rust-resistant composite blade.

The temperature of said ultra-high temperature melting treatment in the step A2 was 1400 to 1800° C.; and the process time was 2 to 60 seconds.

The shape of said preformed body was a planar abutment.

Said blade base material was Martensitic stainless steel

Said ultra-hard alloy material was nickel-based alloy.

Said cooling method was air cooling; the cooling time was 120 minutes, and the temperature was cooled to below 100° C.

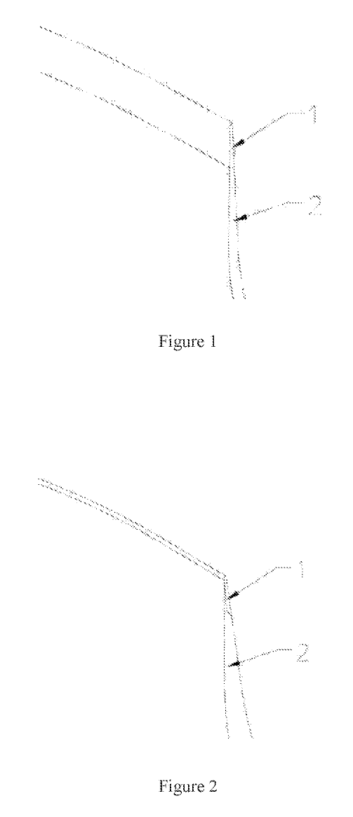

The wear-resistant cutter blade prepared in this embodiment is as shown in FIG. 1. Said wear-resistant cutter blade included a blade tip 1 and a blade base 2, and the blade tip 1 had a hardness of 58 to 75.

### Embodiment 2

This embodiment relates to a method for preparing an ultra-hard and wear-resistant composite blade of a single-sided super wear-resistant cutter, which comprises the following steps:

Step A1, subjecting a blade base material to preform processing and base premolding processing to form a preformed body;

Step A2, adding an ultra-hard alloy material to the preformed body, which is then subjecting to an ultra-high temperature melting treatment to produce a nanoscale ultra-hard alloy body; and

Step A3, after cooling, processing and grinding, according to the blade specifications, the nanoscale ultra-hard alloy body to obtain an ultra-hard, wear-resistant and rust-resistant composite blade.

The temperature of said ultra-high temperature melting treatment in the step A2 was 2400 to 2700° C.; and the process time is 2 to 10 seconds.

The shape of said preformed body was a curved abutment.

Said blade base material was Austenitic stainless steel.

Said ultra-hard alloy material was tungsten carbide cobalt alloy.

Said cooling method was oil cooling; the cooling time was 30 minutes; and the temperature was cooled to below 100° C.

The single-sided super wear-resistant cutter blade prepared in this embodiment is as shown in FIG. 2. Said single-sided super wear-resistant cutter blade included a blade tip 1 and a blade base 2; and the blade tip 1 had a hardness of 58 to 75.

### Embodiment 3

This embodiment relates to a method for preparing an ultra-hard and wear-resistant composite blade of super wear-resistant scissors, which comprises the following steps:

Step A1, subjecting a blade base material to preform processing and base premolding processing to form a preformed body; and

Step A2, adding an ultra-hard alloy material to the preformed body, which is then subjecting to an ultra-high temperature melting treatment to produce a nanoscale ultra-hard alloy body;

Step A3, after cooling, processing and grinding, according to the blade specifications, the nanoscale ultra-hard alloy body to obtain an ultra-hard, wear-resistant and rust-resistant composite blade.

The temperature of said ultra-high temperature melting treatment in the step A2 was 1900 to 2100° C.; and the process time was 30 to 40 seconds.

The shape of said preformed body was a curved abutment.

Said blade base material was titanium alloy.

Said ultra-hard alloy material was ceramic.

Said cooling method was oil cooling; the cooling time was 10 minutes; and the temperature was cooled to below 100° C.

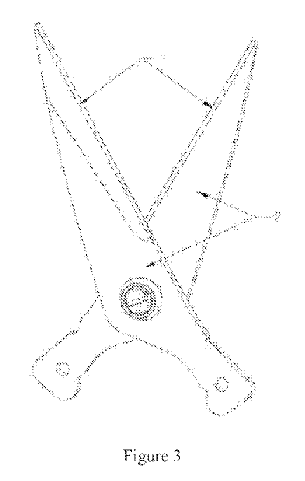

The blades of super wear-resistant scissors prepared in this embodiment is as shown in FIG. 3. Said blades of the super wear-resistant scissors included blade tips 1 and blade bases 2; and the blade tips 1 had a hardness of 58 to 75.

There are many specific applications of the present disclosure, and the above is only the description of preferred embodiments of the present disclosure. It should be noted that the above embodiments are merely illustrative of the disclosure and are not intended to limit the scope of the disclosure. Numerous modifications may be made by those skilled in the art without departing from the principles of the disclosure, and such modifications are also considered to be within the scope of protection of the disclosure.

1. A method for preparing an ultra-hard and wear-resistant composite blade, wherein the method comprises:
Step A1: subjecting the blade base material to preform processing and base premolding processing to form a preformed body;
Step A2: adding an ultra-hard alloy material is added into the preformed body, which is then subjecting to an ultra-high temperature melting treatment to produce; and
Step A3: after cooling, processing and grinding, according to the blade specifications, the nanoscale ultra-hard alloy body to obtain an ultra-hard, wear-resistant and rust-resistant composite blade.

2. The method for preparing an ultra-hard and wear-resistant composite blade according to claim 1, wherein the temperature of the ultra-high temperature melting treatment in the step A2 is 1200 to 2700° C., and the process time is 2 to 60 seconds.

3. The method for preparing an ultra-hard and wear-resistant composite blade according to claim 1, wherein the preformed body has a shape of a planar abutment or a curved abutment.

4. The method for preparing an ultra-hard and wear-resistant composite blade according to claim 1, wherein said blade base material includes at least one selected from the group consisting of Martensitic stainless steel, ferritic stainless steel, Austenitic stainless steel, titanium alloy and rust resistant alloy.

5. The method for preparing an ultra-hard and wear-resistant composite blade according to claim 1, wherein said ultra-hard alloy material includes at least one selected from the group consisting of nickel-based alloy, cobalt-based alloy, iron-based alloy, tungsten carbide composite material, high rust-resistant cemented carbide, ceramic, and synthetic diamond.

6. The method for preparing an ultra-hard and wear-resistant composite blade according to claim 5, wherein said ultra-hard alloy material includes at least one selected from the group consisting of nickel-based alloy, tungsten carbide cobalt alloy, and ceramic

7. The method for preparing an ultra-hard and wear-resistant composite blade according to claim 1, wherein said cooling method is air cooling or oil cooling

8. The method for preparing an ultra-hard and wear-resistant composite blade according to claim 1, wherein said cooling time is 10 to 120 minutes, and the temperature is cooled to 10 to 100° C.

9. Method for using the ultra-hard and wear-resistant composite blade prepared according to the method of claim 1, comprising:
using the ultra-hard and wear-resistant composite blade in preparation of an ultra-hard and wear-resistant cutter, a single-side ultra-hard and wear-resistant cutter or ultra-hard wear-resistant scissors.

10. The method for preparing an ultra-hard and wear-resistant composite blade according to claim 7, wherein said cooling time is 10 to 120 minutes, and the temperature is cooled to 10 to 100° C.
